(19) United States
(12) Patent Application Publication
(10) Pub. No.: US 2005/0274801 A1
(43) Pub. Date: Dec. 15, 2005

(54) Method, apparatus and article for validating ADC devices, such as barcode, RFID and magnetic stripe readers

(75) Inventors: Andrew C. Harding, Kirkland, WA (US); Jeffrey M. Hunt, Woodinville, WA (US); Thomas A. Sweet, Snohomish, WA (US)

Correspondence Address: SEED INTELLECTUAL PROPERTY LAW GROUP PLLC, 701 FIFTH AVENUE, SUITE 6300, SEATTLE, WA, 98104-7092, US

(73) Assignee: Intermec IP Corp., Woodland Hills, CA (US)

(21) Appl. No.: 11/130,792

(22) Filed: May 17, 2005

Related U.S. Application Data
(63) Continuation-in-part of application No. 10/934,064, filed on Sep. 3, 2004.
Application No. 10/934,064 is a division of application No. 09/240,108, filed on Jan. 29, 1999, now Pat. No. 6,857,013.

(51) Int. Cl. G06K 7/00

(52) U.S. Cl. 235/438

(57) ABSTRACT

Reconfiguration and/or upgrade of Automatic Data Collection (ADC) devices such as barcode readers, RFID readers and/or magnetic stripe readers is facilitated by performing adequate testing, prompt accurate analysis of the results of such testing, and prompt delivery of the analysis to those involved with the development of ADC device builds, associated components and/or functionality. The functionality of ADC devices and/or ADC device platforms is determined and appropriate tests are selected and provided to the ADC device and/or ADC device platform for execution. Results are received, analyzed and provided to appropriate users.

### CROSS-REFERENCE TO RELATED APPLICATIONS

This application is a continuation-in-part of U.S. patent application Ser. No. 10/934,064 filed Sep. 3, 2004, which is a divisional of U.S. patent application Ser. No. 09/240,108 filed Jan. 29, 1999.

### BACKGROUND OF THE INVENTION

1. Field of the Invention

The methods, apparatuses and articles described herein generally relate to automatic data collection (ADC) devices, such as readers capable of reading optical machine-readable symbols (e.g. barcodes), radio frequency identification (RFID) tags, and/or magnetic stripes. In particular, the methods, apparatuses and articles described herein facilitate the upgrading, validating and testing of such ADC devices and ADC device platforms.

2. Description of the Related Art

The ADC field is generally directed to the use of devices for automatically capturing data typically encoded in media such as a machine-readable symbol or tag carried by the item to which the data relates. A variety of ADC devices and ADC media are ubiquitous and well known.

For example, readers for optically reading machine-readable symbols such as barcode symbols, matrix or area symbols or stacked symbols are common in a large variety of retail, warehouse and shipping environments. Such readers are commonly referred to as “barcode” readers, and typically take the form of either optical scanners or optical imagers. Optical readers may be fixed, such as those typically found at many grocery or supermarket checkout stands where the item bearing the machine-readable symbol is passed over the optical reader. Handheld optical readers are also common, where the operator either moves the optical reader to scan the desired machine-readable symbol or generally aims the optical reader at the desired machine-readable symbol and optionally activates a trigger or other switch to cause the optical reader to scan or capture an image of the machine-readable symbol.

RFID readers are becoming increasingly more common in retail, warehouse, and shipping environments. RFID readers wirelessly read and/or write information to RFID tags. Such RFID readers may be either fixed or handheld. RFID readers may operate with active RFID tags which contain a discrete power source such as a battery or ultra-capacitor, or may operate with passive RFID tags which derive power from an RF interrogation signal transmitted by the RFID reader. RFID tags may, or may not, include encryption and other security measures for controlling access to the data stored in the RFID tag.

Magnetic stripe readers are commonly found in a large variety of environments, such as in point-of-sale (POS) terminals for reading magnetic stripes carried by various media, for example financial cards such as credit cards, debit cards, and/or gift cards. Magnetic stripe readers typically rely on movement of the media relative to a magnetic reader head to magnetically capture the information encoded in the polarizations of the magnetic stripe.

An ADC device platform typically includes one or more ADC devices. For example, a POS terminal may include a barcode reader and a magnetic stripe reader, in addition to a keyboard, display, processor and cash drawer most commonly associated with traditional cash registers. In turn, the ADC devices may employ components or subsystems, which may or may not be modularized for easy replacement or substitution. For example, an optical reader may include a scan engine, an illumination system, an image capture device, and/or a decode section. An RFID reader may include a separate transmitter and receiver, along with associated antennas.

The ability to add additional ADC devices to an ADC device platform, and/or upgrade ADC devices or components on an ADC platform would be highly desirable to both the consumer and the manufacturers or suppliers of ADC platforms and devices. One problem that has hindered the ability to add or upgrade ADC devices or components on an ADC device platform is the extensive testing of new or upgraded ADC devices, associated components and/or functionality that must be performed to ensure that the ADC devices, associated components and/or functionality will work with the large number of existing ADC device platforms with respect to hardware, firmware and/or software. A related problem is the large amount of technical support and analysis that the manufacturer or supplier must typically supply the consumer to ensure that the ADC device and/or associated firmware or software is correctly installed, configured and/or operated. This problem is particularly exacerbated where initial testing of the “build” has not been adequately validated and tested, for example using regression techniques, before release of the new or upgraded ADC device, associated component and/or functionality.

### BRIEF SUMMARY OF THE INVENTION

Adequate testing, prompt accurate analysis of the results of such testing, and prompt delivery of the analysis to those involved with the development of ADC devices, associated components and/or functionality would facilitate the ability to add or upgrade ADC devices, associated components and/or functionality.

In one aspect, a method of operating a validation system to validate automatic data collection devices comprises automatically determining at least one data collection capability of an automatic data collection device remotely located from a validation system; determining at least one test appropriate for testing the at least one data collection capability of the automatic data collection device based on the determined at least one capability of the automatic data collection device; providing the determined at least one test to the automatic data collection device for execution; and receiving a set of results from the execution of the determined at least one test by the automatic data collection device.

In another aspect, a validation system to validate automatic data collection devices comprises means for automatically determining at least one data collection capability of an automatic data collection device remotely located from a validation system; means for determining at least one test appropriate for testing the at least one data collection capability of the automatic data collection device based on the determined at least one capability of the automatic data collection device; means for providing the determined at least one test to the automatic data collection device for execution; and means for receiving a set of results from the execution of the determined at least one test by the automatic data collection device.

In a further aspect, a method of assessing automatic data collection devices comprises automatically determining at least one capability of at least one of an automatic data collection device platform and/or an automatic data collection device associated with the automatic data collection platform; determining at least one appropriate test based on the determined capability of the automatic data collection device platform and/or automatic data collection device; providing the determined at least one appropriate test to the automatic data collection device platform and/or automatic data collection device; and receiving results from the execution of the determined at least one appropriate test.

In yet a further aspect, a validation system to validate automatic data collection devices comprises at least one processor; a communications port operable to communicatively couple the processor to the automatic data collection devices; and at least one processor readable medium storing instructions for causing the at least one processor to validate automatic data collection devices by: automatically determining at least one capability of at least one of an automatic data collection device platform and/or an automatic data collection device associated with the automatic data collection platform; determining at least one appropriate test based on the determined capability of the automatic data collection device platform and/or automatic data collection device; providing the determined at least one appropriate test to the automatic data collection device platform and/or the automatic data collection device; and receiving results from the execution of the determined at least one appropriate test.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram of a networked environment in which at least one exemplary embodiment may operate.

FIG. 2 is a functional block diagram of a computing system suitable for use in the networked environment of FIG. 1, according to one illustrated embodiment.

FIG. 3 is a high level flow diagram showing a method of facilitating the upgrading, validating and testing of an ADC device in the networked environment according to one illustrated embodiment.

FIGS. 4A-4D are a low level flow diagram showing a method of determining an appropriate test for the ADC device according to one illustrated embodiment.

FIG. 5 is a low level flow diagram showing a method of determining an appropriate test for the ADC device platform according to one illustrated embodiment.

### DETAILED DESCRIPTION OF THE INVENTION

In the following description, certain specific details are set forth in order to provide a thorough understanding of various embodiments of the invention. However, one skilled in the relevant art will recognize that the invention may be practiced without one or more of these specific details, or with other methods, components, materials, etc. In other instances, well known structures associated with ADC devices such as optical readers for reading machine-readable symbols, RFID readers for reading RFID tags, magnetic stripe readers for reading magnetic stripes, as well as computers, networks, and databases have not been shown or described in detail to avoid unnecessarily obscuring descriptions of the embodiments of the invention.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

The headings provided herein are for convenience only and do not interpret the scope or meaning of the claimed invention.

Networked Environment

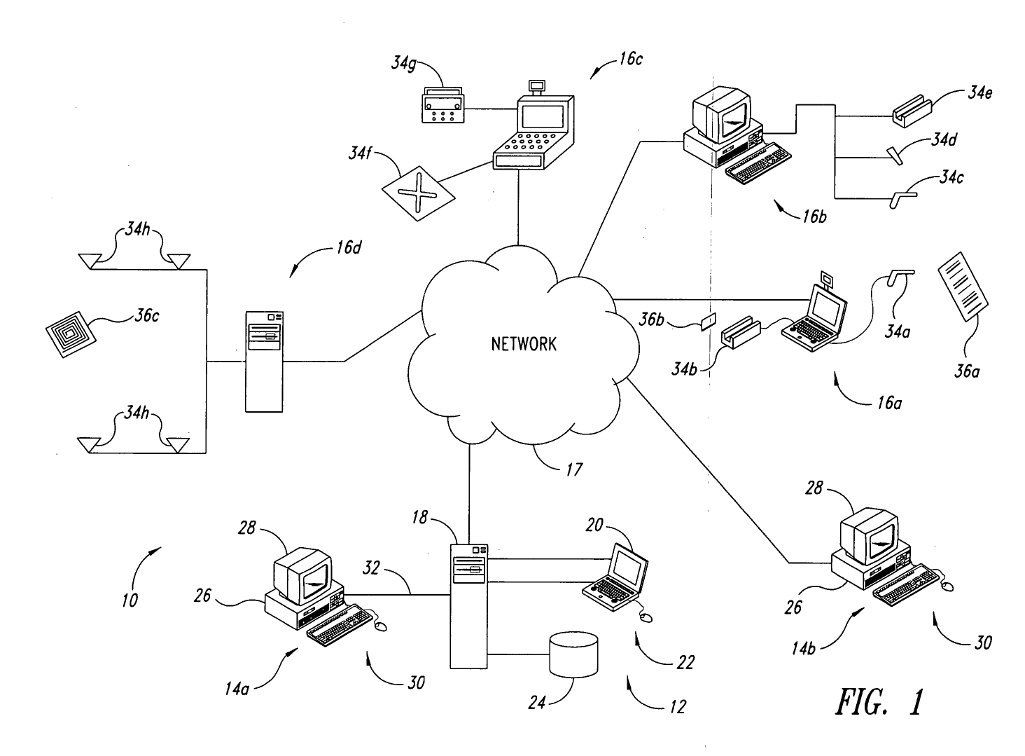

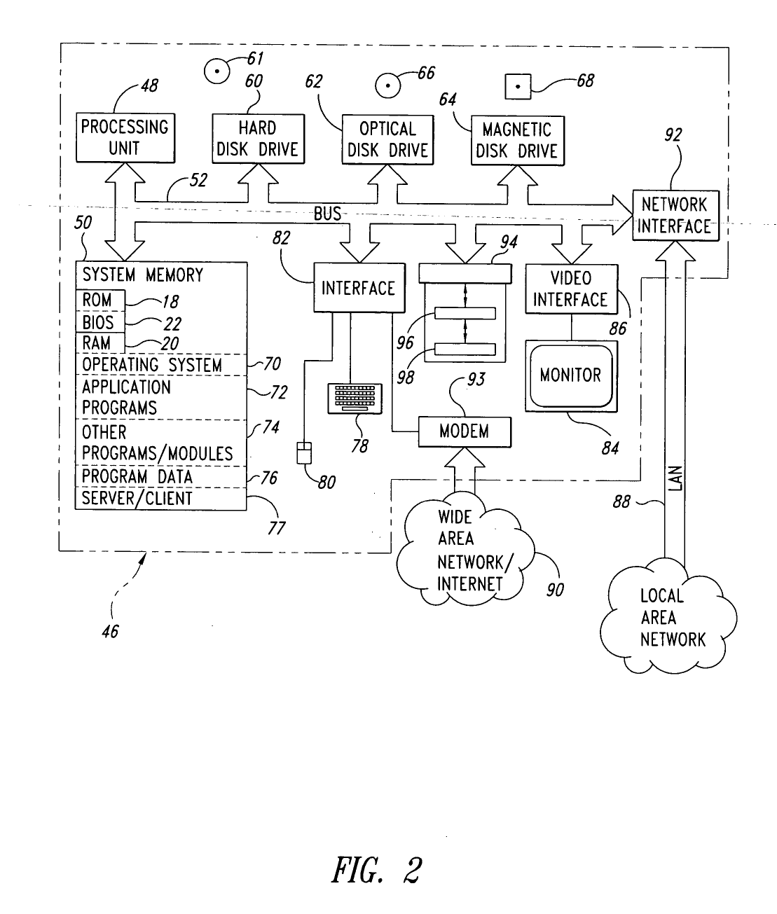

FIGS. 1 and 2, and the following discussion provide a brief general description of a suitable environment in which embodiments may be implemented. Although not required, embodiments will be described in the general context of computer executable instructions, such as program application modules, objects, or macros being executed by a computer. Those skilled in the relevant art will appreciate that the invention can be practiced with other system configurations including handheld devices, multiprocessor systems, microprocessor based or programmable consumer electronics, network PCs, minicomputers, mainframe computers, and the like. Embodiments can be practiced in distributed environments where tasks or modules are performed by remote processing devices, which are linked through a communications network. In a distributed environment, programming modules may be located in both local and remote memory storage devices.

In particular, FIG. 1 shows a networked environment 10 comprising a validation computing system 12, designer operated computing systems 14a, 14b and automated data collection device platforms 16a-16d, all communicatively coupled via a network 17 such as a local area network (LAN), and/or wide area network (WAN) such as the internet. The network 17 may take the form of one or more extranets or intranets, or other types of networks, and can employ any of a variety of network architectures. The validation computing system 12, designer operated computing systems 14a, 14b and/or automated data collection device platforms 16a-16d may alternatively or additional employ point-to-point communications.

Validation Computing System

As described in more detail below, the validation computing system 12 may take the form of a computer such as a server computer 18 and may optionally include a monitor 20 and one or more user input devices 22 such as a keyboard, keypad, mouse, trackball, digitizing tablet and/or touch screen display. The validation computing system 12 may also include one or more storage devices 24 for storing information such as one or more databases. While illustrated as being external to the server computer 18, one or more of the data storage devices 24 may be located internally in a housing of the server computer 18.

Designer Operated Computing Systems

The designer operated computing systems 14a, 14b may take the form of a personal computer (PC), mini- or microcomputer and/or workstation 26 configured to function as a server and/or client, and may optionally include a monitor 28 and one or more user input devices 30 such as a keyboard, keypad, mouse, trackball, digitizing tablet, and/or touch screen display. Some of the designer operated computing systems 14a may be communicatively coupled to the validation computing system 12 via a local area network 32, while others of the designer operated computing systems 14b may be coupled to the validation computing system 12 via the wide area network 17.

ADC Device Platforms

The ADC device platforms 16a-16d may take a variety of forms, each of which comprises one or more ADC devices.

The ADC device platform 16a may, for example, take the form of a point-of-sale (POS) terminal commonly found at retail locations. The POS terminal may include a handheld optical reading device 34a for optically reading symbols such as machine-readable barcode symbols 36a carried by items or tags. The handheld optical reading device 34a may include an image capture device, for example a linear imager or a two-dimensional imager, for capturing an image of the machine-readable symbol 36a. The handheld optical reading device 34a may optionally include an illumination system, for example a flood illumination system, for illuminating the machine-readable symbol 36a. The ADC device platform 16a may also include an employee operated magnetic stripe reader 34b for reading information encoded in a magnetic stripe carried on a card 36b such as a credit card, debit card and/or a gift card.

Another ADC device platform 16b may take the form of a personal computer with a variety of ADC devices coupled via a serial port, the personal computer storing and executing instructions for processing data captured by the ADC devices. In particular, the ADC devices may include a handheld RFID reader 34c operable for wirelessly reading or interrogating RFID tags. The ADC devices may include a handheld wand style machine-readable symbol reader 34d. The wand style machine-readable symbol reader 34d may be moved across a machine-readable symbol in order to capture the information encoded in the machine-readable symbol via scanning. The ADC device platform 16b may further include a magnetic stripe reader 34e.

A further ADC device platform 16c may take the form of a POS terminal, such as those commonly found in retail stores such as grocery or supermarkets. Such an ADC device platform 16c may include a fixed barcode scanner 34f. Items bearing machine-readable symbols may be passed over the fixed barcode scanner 34f to capture the information encoded in the machine-readable symbol by scanning. The ADC device platform 16c may also include a customer operated magnetic stripe reader 34g. The magnetic stripe reader 34g may be similar to those commonly found in retail stores such as grocery or supermarkets, which allow the customer to make payment by credit, debit and/or gift cards. Such magnetic stripe readers typically include a keypad that allows the customer to enter information such as a personal identity number (PIN), and to make a selection, such as whether to receive cash back from the retailer.

Yet another ADC device platform 16d may take the form of a fixed RFID interrogation system including a set of transceivers and antennas 34h distributed about a facility for wirelessly reading RFID tags 36c encoding information to determine the presence or absence, location or position, and/or information encoded in, the RFID tags 36c. The transceivers and antennas 34h may be communicatively coupled via a network to one or more centralized computing systems that operates and/or collects data read from the RFID tags 36c. The facility may take a variety of forms, for example, a manufacturing facility, warehouse, shipping center and/or retail store.

One or more ADC devices 34a-34h may be integrated into the ADC platform 16a-16d, or may be communicatively coupled to the ADC device platform 16a, 16d by wired connections, for example serial cables and/or parallel cables, and/or wireless connections, for example infrared transceivers or Bluetooth transceivers.

Computing Systems

In particular, FIG. 2 shows a conventional personal computer referred to herein as computing system 46 that may be appropriately configured to function as either the verification computing system 12, as one of the designer operated computing systems 14a-14b, or as the computing system portion of one of the automatic data collection platforms 16a-16d.

The computing system 46 includes a processing unit 48, a system memory 50 and a system bus 52 that couples various system components including the system memory 50 to the processing unit 48. The processing unit 48 may be any logical processing unit, such as one or more central processing units (CPUs), digital signal processors (DSPs), application-specific integrated circuits (ASICs), etc. Unless described otherwise, the construction and operation of the various blocks shown in FIG. 2 are of conventional design. As a result, such blocks need not be described in further detail herein, as they will be understood by those skilled in the relevant art.

The system bus 52 can employ any known bus structures or architectures, including a memory bus with memory controller, a peripheral bus, and/or a local bus. The system memory 50 includes read-only memory (“ROM”) 54 and random access memory (“RAM”) 56. A basic input/output system (“BIOS”) 58, which can form part of the ROM 54, contains basic routines that help transfer information between elements within the computing system 46, such as during startup.

The computing system 46 also includes one or more spinning media memories such as a hard disk drive 60 for reading from and writing to a hard disk 61, and an optical disk drive 62 and a magnetic disk drive 64 for reading from and writing to removable optical disks 66 and magnetic disks 68, respectively. The optical disk 66 can be a CD-ROM, while the magnetic disk 68 can be a magnetic floppy disk or diskette. The hard disk drive 60, optical disk drive 62 and magnetic disk drive 64 communicate with the processing unit 48 via the bus 52. The hard disk drive 60, optical disk drive 62 and magnetic disk drive 64 may include interfaces or controllers coupled between such drives and the bus 52, as is known by those skilled in the relevant art, for example via an IDE (i.e., Integrated Drive Electronics) interface. The drives 60, 62 and 64, and their associated computer-readable media 61, 66 and 68, provide nonvolatile storage of computer-readable instructions, data structures, program modules and other data for the computing system 46. Although the depicted computing system 46 employs hard disk 61, optical disk 66 and magnetic disk 68, those skilled in the relevant art will appreciate that other types of spinning media memory computer-readable media may be employed, such as digital video disks (“DVDs”), Bernoulli cartridges, etc. Those skilled in the relevant art will also appreciate that other types of computer-readable media that can store data accessible by a computer may be employed, for example, non-spinning media memories such as magnetic cassettes, flash memory cards, RAMs, ROMs, smart cards, etc.

Program modules can be stored in the system memory 50, such as an operating system 70, one or more application programs 72, other programs or modules 74, and program data 76. The applications programs 72 may include one or more programs for locating ADC device platforms and/or ADC devices, selecting appropriate tests, analyzing results of the tests, and delivering the analysis in order to validate ADC device builds. The system memory 50 also includes one or more communications programs 77 for permitting the computing system 46 to access and exchange data with sources such as websites of the Internet, corporate intranets, or other networks, as well as other server applications on server computers. The communications program 77 may take the form of a server program, particularly where the computing system 46 implements the server computer 18 (FIG. 1). Alternatively, or additionally, the communications program may take the form of a browser program, particularly where the computing system 46 implements the designer operated computing systems 14a, 14b and/or ADC device platforms 16a-16d (FIG. 1). The communications program 77 may be markup language based, such as hypertext markup language (“HTML”), Extensible Markup Language (XML) or Wireless Markup Language (WML), and operate with markup languages that use syntactically delimited characters added to the data of a document to represent the structure of the document. A number of Web clients or browsers are commercially available such as NETSCAPE NAVIGATOR® from America Online, and INTERNET EXPLORER® available from Microsoft Corporation of Redmond Wash.

While shown in FIG. 2 as being stored in the system memory 50, the operating system 70, application programs 72, other program modules 74, program data 76 and communications program 77 can be stored on the hard disk 61 of the hard disk drive 60, the optical disk 66 and the optical disk drive 62 and/or the magnetic disk 68 of the magnetic disk drive 64.

A user can enter commands and information to the computing system 46 through input devices such as a keyboard 78 and a pointing device such as a mouse 80. Other input devices can include a microphone, joystick, game pad, scanner, etc. These and other input devices are connected to the processing unit 48 through an interface 82 such as a serial port interface that couples to the bus 52, although other interfaces such as a parallel port, a game port or a universal serial bus (“USB”) can be used. A monitor 84 or other display devices may be coupled to the bus 52 via video interface 86, such as a video adapter. The computing system 46 can include other output devices such as speakers, printers, etc.

The computing system 46 can operate in a networked environment 10 (FIG. 1) using logical connections to one or more remote computers. The computing system 46 may employ any known means of communications, such as through a local area network (“LAN”) 88 or a wide area network (“WAN”) or the Internet 90. Such networking environments are well known in enterprise-wide computer networks, intranets, extranets, and the Internet.

When used in a LAN networking environment, the computing system 46 is connected to the LAN 88 through an adapter or network interface 92 (communicatively linked to the bus 52). When used in a WAN networking environment, the computing system 46 often includes a modem 93 or other device for establishing communications over the WAN/Internet 90. The modem 93 is shown in FIG. 2 as communicatively linked between the interface 82 and the WAN/Internet 90. In a networked environment, program modules, application programs, or data, or portions thereof, can be stored in a server computer (not shown). Those skilled in the relevant art will readily recognize that the network connections shown in FIG. 2 are only some examples of establishing communications links between computers, and other communications links may be used, including wireless links.

The computing system 46 may include one or more interfaces such as slot 94 to allow the addition of devices 96, 98 either internally or externally to the computing system 46. For example, suitable interfaces may include ISA (i.e., Industry Standard Architecture), IDE, PCI (i.e., Personal Computer Interface) and/or AGP (i.e., Advance Graphics Processor) slot connectors for option cards, serial and/or parallel ports, USB ports (i.e., Universal Serial Bus), audio input/output (i.e., I/O) and MIDI/joystick connectors, and/or slots for memory.

The term “computer-readable medium” as used herein refers to any medium that participates in providing instructions to processing unit 48 for execution. Such a medium may take many forms, including but not limited to, non-volatile media, volatile media, and transmission media. Non-volatile media includes, for example, hard, optical or magnetic disks 61, 66, 68, respectively. Volatile media includes dynamic memory, such as system memory 50. Transmission media includes coaxial cables, copper wire and fiber optics, including the wires that comprise system bus 52. Transmission media can also take the form of acoustic or light waves, such as those generated during radio wave and infrared data communications.

Common forms of computer-readable media include, for example, floppy disk, flexible disk, hard disk, magnetic tape, or any other magnetic medium, CD-ROM, any other optical medium, punch cards, paper tape, any other physical medium with patterns of holes, RAM, PROM, EPROM, EEPROM, FLASH memory, any other memory chip or cartridge, a carrier wave as described herein, or any other medium from which a computer can read.

Various forms of computer readable media may be involved in carrying one or more sequences of one or more instructions to processing unit 48 for execution. For example, the instructions may initially be carried on a magnetic disk of a remote computer. The remote computer can load the instructions into its dynamic memory and send the instructions over a telephone line using a modem. A modem 93 local to computer system 46 can receive the data on the telephone line and use an infrared transmitter to convert the data to an infrared signal. An infrared detector coupled to the system bus 52 can receive the data carried in the infrared signal and place the data on system bus 52. The system bus 52 carries the data to system memory 50, from which processing unit 48 retrieves and executes the instructions. The instructions received by system memory 50 may optionally be stored on a storage device either before or after execution by processing unit 48.

High Level Operation

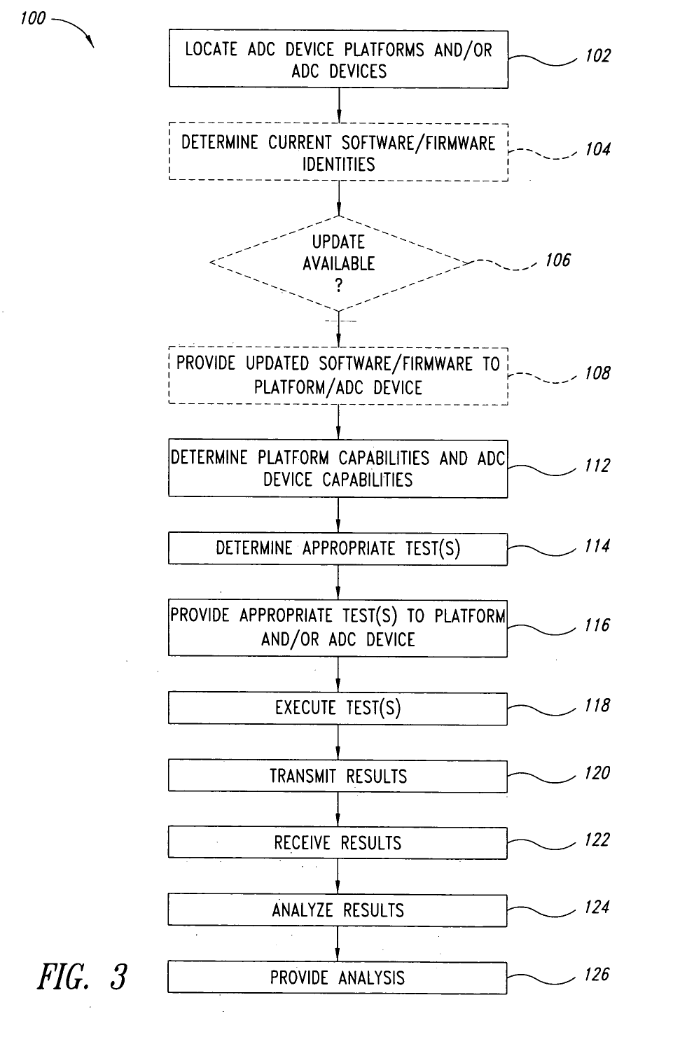

FIG. 3 is a flow diagram of a high level method 100 of validating ADC device builds according to one illustrated embodiment.

At 102, the validation computing system 12 locates ADC device platforms 16a-16d and/or ADC devices 34a-34h. The validation computing system 12 may locate ADC device platforms 16a-16d and/or ADC devices 34a-34h by probing the network 17 with inquiries, for example, by broadcasting network messages of local connections through ActiveSync software available from Microsoft Corporation of Redmond, Wash. The validation computing system 12 may use a spider or crawler type program. Alternatively, or additionally, the validation computing system 12 may locate ADC device platforms 16a-16d and/or ADC devices 34a-34h by checking a repository of information, for example stored at storage device 24. Alternatively, users of the system may provide static addresses and device network names.

Optionally at 104, the validation computing system 12 determines the current software and/or firmware identities for the located ADC device platforms 16a-16d and/or ADC devices 34a-34h. Thus, the validation computing system 12 identifies the most recent revision of software and/or firmware being executed by ADC device platforms 16a-16d and/or ADC devices 34a-34h. For example, the validation computing system 12 may transmit an inquiry to the ADC device platforms 16a-16d and/or ADC devices 34a-34h. Alternatively, or additionally, the validation computing system 12 may check a repository of such information, which may, for example, be stored at the storage device 24 (FIG. 1).

Optionally at 106, the validation computing system 12 determines whether an update to the software and/or firmware is available. The validation computing system 12 may check a repository of such information, which may, for example, be stored at the storage device 24 (FIG. 1).

Optionally at 108, the validation computing system 12 provides the updated software and/or firmware to the ADC device platform 16a-16d and/or ADC device 34a-34h. The validation computing system 12 may also receive confirmation that the ADC device platform 16a-16d and/or ADC device 34a-34h has successfully loaded the updated software and/or firmware, and is executing the most recent versions of such software and/or firmware.

At 112, the validation computing system 12 determines the capabilities of the ADC device platform 16a-16d and/or the ADC device 34a-34h.

The validation computing system 12 may determine the capabilities of the ADC device platform 16a-16d and/or the ADC device 34a-34h by interrogating the ADC device platform 16a-16d to determine the specific features associated with the ADC device platform 16a-16d. The validation computing system 12 may employ a product configuration matrix (PCM), as well as other device specific application programming interfaces (APIs) and methods to determine the specific features.

Determining the capabilities of the ADC devices 34a-34h may be based at least in part on the determined abilities of the specific ADC device platform 16a-16d. For example, if the validation computing system 12 determines that the specific ADC device platform 16a-16d is Bluetooth capable, the validation computing system 12 will attempt to locate any Bluetooth ADC devices 34a-34h wirelessly connected to the specific ADC device platform 16a-16d. Also for example, if the validation computing system 12 determines that the specific ADC device platform 16a-16d includes an internal machine-readable symbol reader (e.g., scanner or imager), the validation computing system 12 determines and notes the functionality of such machine-readable symbol reader. As a further example, if the validation computing system 12 determines that the specific ADC device platform 16a-16d has one or more serial ports, the validation computing system 12 attempts to locate and identify ADC devices 34a-34h tethered to the specific ADC device platform 16a-16d via the serial ports.

The validation computing system 12 may determine the specific functionality or ability of each ADC device 34a-34h using ISCP commands passed to the ADC device 34a-34h via an IADC device API. The ISPC commands may, for example, be used to determine which machine-readable symbologies, preambles, post-ambles, and/or which protocols (e.g., frequency, encoding scheme such as TDMA, FDMA, CDMA) the ADC device is configured to handle.

At 114, the validation computing system 12 determines one or more appropriate tests to be run on the ADC device platform 16a-16b and/or ADC device 34a-34h. For example, the validation computing system 12 may compare an identifier such as a PCM for the ADC device platform 16a-16d and/or ADC device 34a-34h, with a mask to determine one or more appropriate tests. Thus, the validation computing system 12 may compare the PCM CQ46CA0102403801 associated with one of the ADC device platforms 16a-16d and/or ADC devices 34a-34h with the mask CQ46C**1******** where the matching symbols (i.e., alpha/numeric values) indicate that the device has Bluetooth functionality, and identify a specific test and location of the specific test. Such a method is described in more detail in commonly assigned U.S. application Ser. No. 10/804,820, filed Mar. 19, 2004.

The appropriate test may be selected from a set of defined tests, for example, stored in storage device 24 (FIG. 1). Additionally or alternatively, the validation computing system 12 may allow a new test to be generated where a defined appropriate test does not exist. The new test may be generated from scratch, or may be created using portions of one or more existing tests.

At 116, the validation computing system 12 provides the appropriate one or more tests to the ADC device platform 16a-16b and/or ADC device 34a-34h. The validation computing system 12 may supply the test over the network 17 (FIG. 1), for example, as an applet or other executable set of instructions. The test may, for example, be transmitted as a Markup Language file or part of a Markup Language file such as an HTML, XML or WML file.

At 118, the ADC device platform 16a-16b and/or the ADC device 34a-34h executes the one or more tests. For example, if the ADC device platform 16a-16d has an internal machine-readable symbol reader such as an imager and the machine-readable symbologies supported by the ADC device platform are known, the machine-readable symbols for testing the ADC device platform may be generated. For example, the test may cause the ADC device platform 16a-16d to display barcode symbols on an LCD display for imaging by an ADC device 34a-34h employing an imager for reading machine-readable symbols. Alternatively or additionally, the test may cause the ADC device platform 16a-16d to print barcode symbols for scanning by an ADC device 34a-34h employing a scanner or scan engine for reading machine-readable symbols.

At 120, the ADC device platform 16a-16b and/or ADC device 34a-34h transmits results from the test to the validation computing system 12.

At 122, the validation computing system 12 receives results from the test. At 124, the validation computing system 12 analyzes the results. The validation computing system 12 knows the contents of the tests, for example, the information encoded in the machine-readable symbols, the RFID tags and/or magnetic stripes. The validation computing system 12 may also know the expected success and failure rates for various ADC devices 34a-34h and/or ADC device platforms 16a-16d.

At 126, the validation computing system timely provides the analysis to specific users, for example the designers of the particular build of the ADC device or component. The specific users may be identified as the users who were involved in the build of the specific product being tested, and/or may be users who have registered to receive such analysis. The user may register to receive analysis on a companywide basis or on a product-by-product basis. The analysis may be provided in the form of a report with or without graphical representation of the test results and analysis of the test results.

Low Level Method-Selecting Appropriate Test for ADC Device

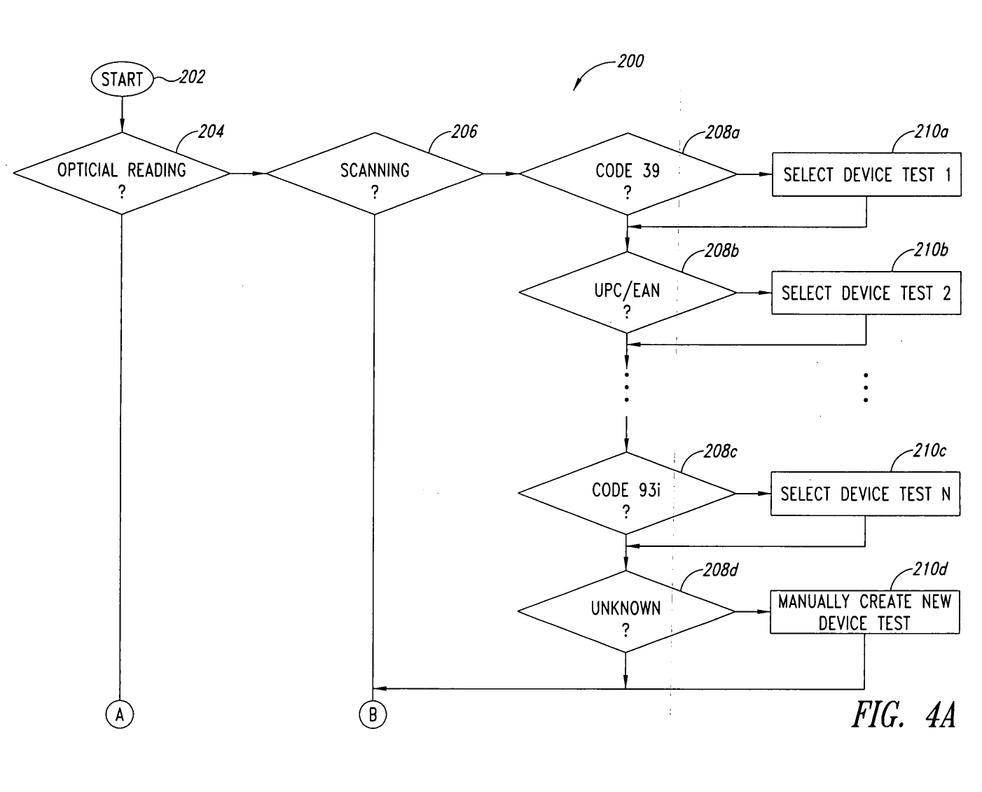

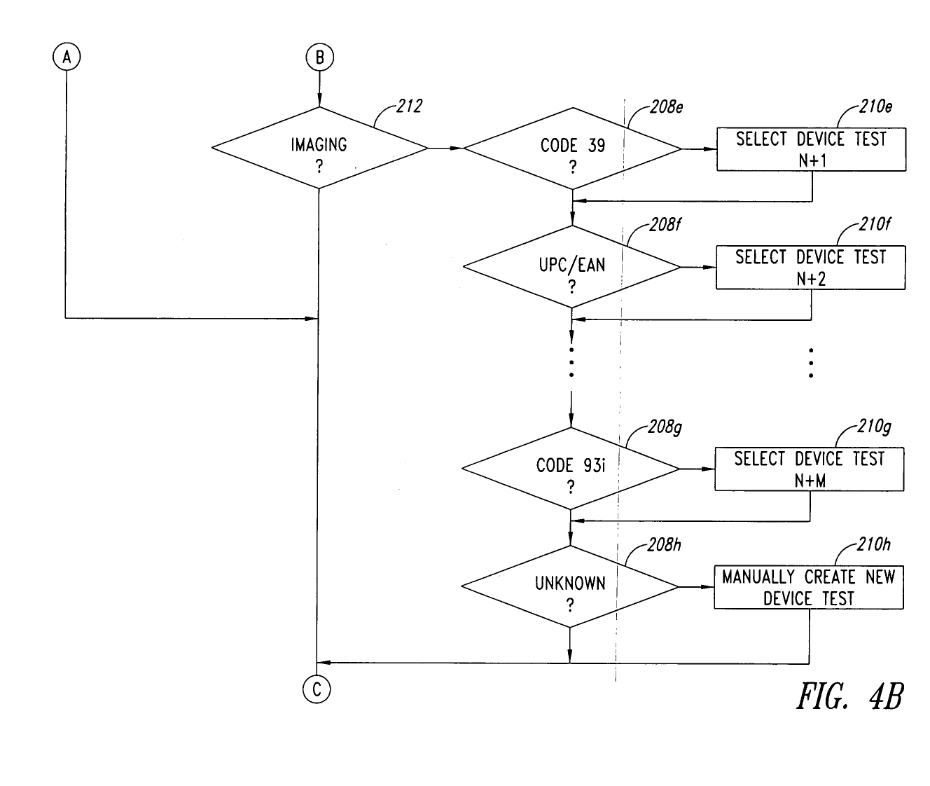

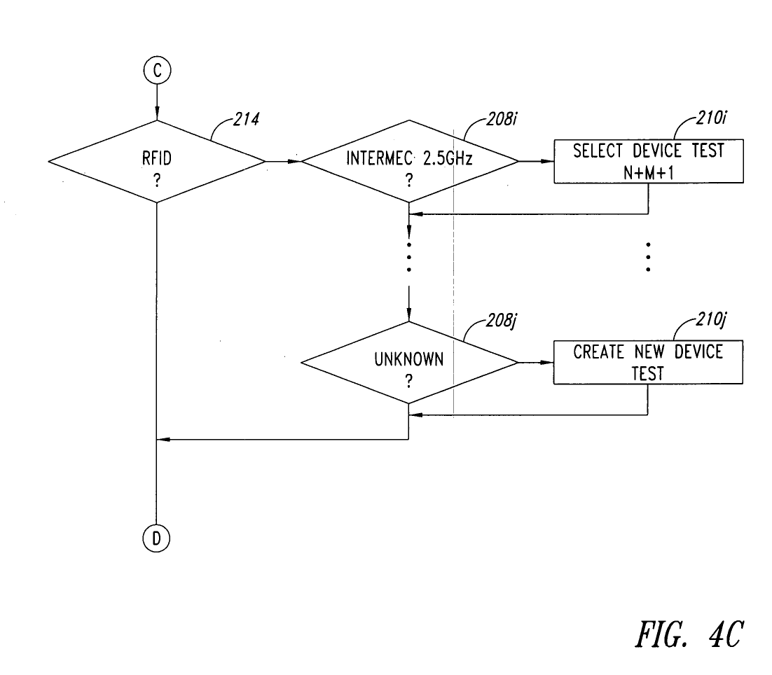

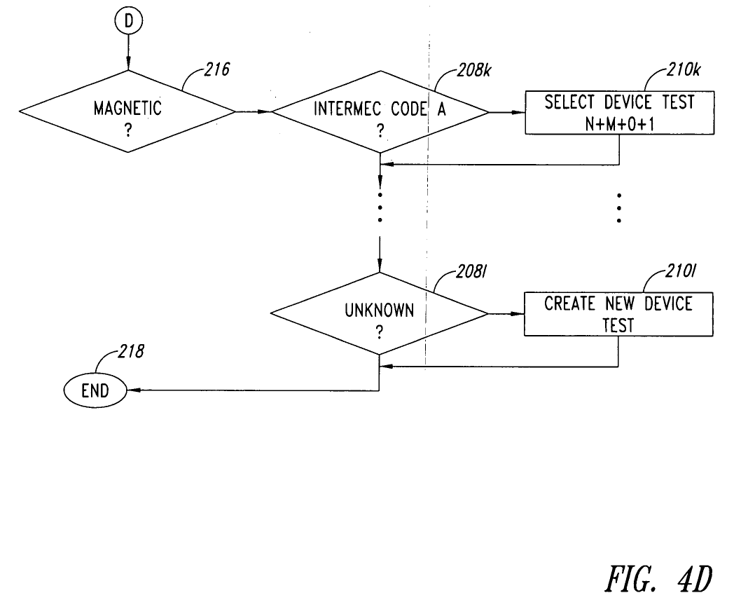

FIGS. 4A-4D are a flow diagram of a low level method of determining an appropriate ADC device test based on the capabilities of an ADC device and/or ADC device platform, according to one illustrated embodiment starting at 202.

At 204, the validation computing system 12 determines whether the ADC device 34a-34h is capable of optical reading. If the ADC device 34a-34h is capable of optical reading, the validation computing system 12 determines at 206 whether the ADC device 34a-34h is capable of scanning. If the ADC device 34a-34h is capable of scanning, the validation system 12 determines at 208a-208d the type of machine-readable symbology that the ADC device 34a-34h is capable of scanning and decoding. At 210a-210c the validation computing system 12 selects a defined ADC device test based on the ability of the ADC device 34a-34h to scan certain machine-readable symbols (e.g., barcodes such as Code 39, Code 93i, UPC/EAN). At 208, if the validation computing system 12 determines that the ADC device 34a-34h is capable of scanning and/or decoding an unknown machine-readable symbology, the validation computing system 12 allows the creation of a new ADC device test at 210d.

Whether the ADC device 34a-34h is capable of scanning or not, the validation computing system 12 determines at 212 whether the ADC device 34a-34h is capable of imaging machine-readable symbols. If the ADC device 34a-34h is capable of imaging machine-readable symbols, the validation computing system 12 determines the symbologies which the ADC device 34a-34h is capable of imaging and/or decoding at 208e-208h. At 210e-210g, the validation computing system 12 selects an appropriate ADC device test based on the particular machine-readable symbologies which the ADC device 34a-34h is capable of imaging and/or decoding. If at 208h, it is determined that the ADC device 34a-34h is capable of imaging and/or decoding an unknown machine-readable symbology, the validation computing system 12 allows the creation of a new ADC device test at 210h.

Whether or not the ADC device 34a-34h is capable of optical reading, at 214, the validation computing system determines whether the ADC device 34a-34h is capable of reading RFID tags 36c. If the ADC device 34a-34h is capable of reading RFID tags 36c, the validation computing system 12 determines a frequency (e.g., 15 MHz, 2.5 GHz) and/or protocol (TDMA, FDMA, CDMA, spread-spectrum) which the ADC device 34a-34h is capable of handling at 208i-208j. The validation computing system 12 selects an appropriate ADC device test based on the determination. If at 208j it is determined that the ADC device 34a-34h is capable of reading an RFID frequency and/or protocol that is otherwise unknown, the validation computing system 12 allows the creation of a new ADC device test at 210j.

Whether or not the ADC device 34a-34h is capable of reading RFID tags 36c, the validation computing system 12 determines at 216, whether the ADC device 34a-34h is capable of reading magnetic encoded material such as a magnetic stripe carried by a card 36b. If the ADC device 34a-34h is capable of reading magnetic information, the validation computing system 12 determines an encodation protocol that the ADC device 34a-34h is capable of handling at 208k-208l. The validation computing system 12 then selects the defined ADC device test at 210k or if the protocol is unknown allows a new ADC device test to be created at 210l. The method 200 terminates at 218.

Low Level Operation-Selecting Appropriate Test for ADC Device Platform

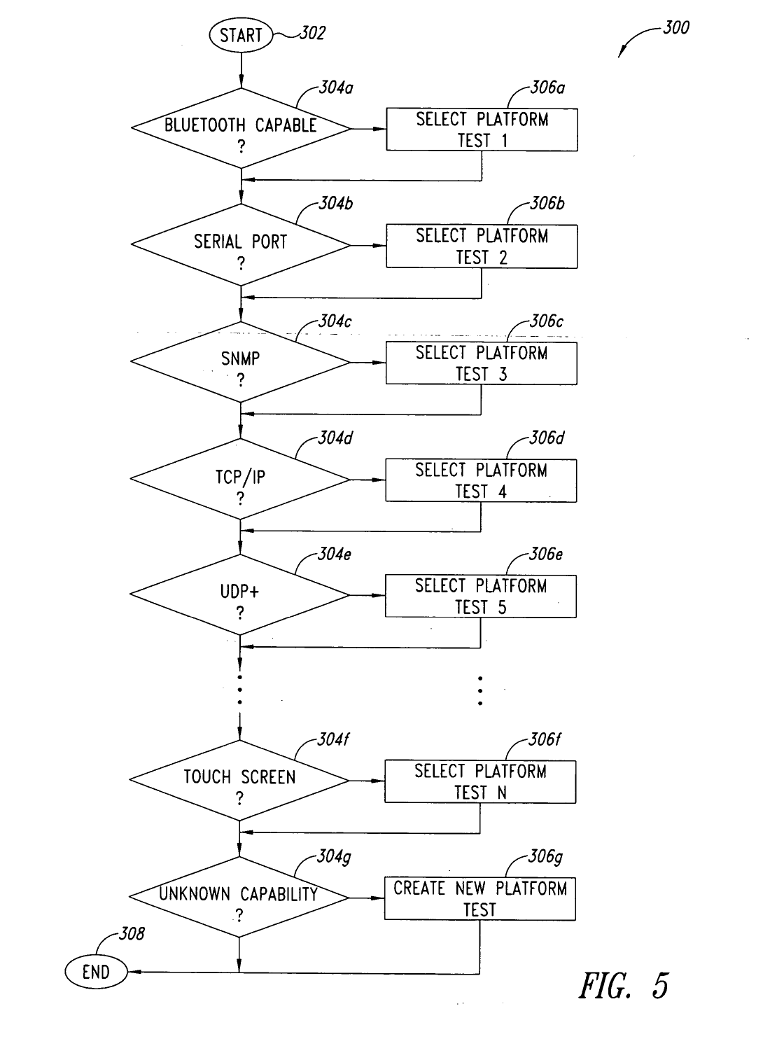

FIG. 5 is a flow diagram of a low level method of determining an appropriate test based at least in part on the platform capabilities of an ADC device platform 16a-16d, according to one illustrated embodiment starting at 302.

At 304a-304g, the validation computing system 12 determines a platform capability of the ADC device platform 16a-16d. For example, at 304a the validation computing system 12 may determine whether the ADC device platform 16a-16d is Bluetooth capable. If the ADC device platform 16a-16d is Bluetooth capable, the validation computing system selects an appropriate platform test at 306a. Also for example, the validation computing system 12 may determine whether the ADC device platform 16a-16d has a serial port and/or appropriate software and hardware for handling serial input and/or output. The validation computing system 12 can then select an appropriate platform test at 306b. At 304c the validation computing system determines whether the ADC device platform 16a-16d is SNMP compliant, selecting an appropriate platform test at 306c. At 304d the validation computing system 12 determines whether the ADC device platform 16a-16d is TCP/IP compliant, selecting an appropriate platform test at 306d. At 304e, the validation computing system 12 determines whether the ADC device platform 16a-16d is UDP+ compliant, selecting an appropriate platform test at 306e.

In this manner the validation computing system 12 may determine platform capabilities of the ADC device platform 16a-16d such as other communications capabilities, as well as other capabilities of the ADC device platform 16a-16d. For example, at 304f the validation computing system 12 may determine whether the ADC device platform 16a-16d has a touch screen, selecting an appropriate test at 306f. At 304g, the validation computing system 12 determines whether the ADC device platform 16a-16d has a previously undefined capability, allowing a new platform test to be defined at 306g. The method 300 terminates at 308.

The above description of illustrated embodiments is not intended to be exhaustive or to limit the invention to the precise forms disclosed. Although specific embodiments and examples are described herein for illustrative purposes, various equivalent modifications can be made without departing from the spirit and scope of the invention, as will be recognized by those skilled in the relevant art. The teachings provided herein of the invention can be applied to other ADC devices such as optical tag readers and touch memory readers, not necessarily the exemplary machine-readable symbol, RFID and/or magnetic stripe readers generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via application-specific integrated circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers), as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including but not limited to: U.S. provisional application Ser. No. 60/084,272, filed May 4, 1998; U.S. provisional application Ser. No. 60/102,360, filed Sep. 29, 1998; U.S. application Ser. No. 09/240,108, filed Jan. 29, 1999; U.S. provisional application Ser. No. 60/155,502, filed Sep. 22, 1999; U.S. Pat. No. 6,539,422, issued Mar. 25, 2003; U.S. Pat. No. 6,618,162 issued Sep. 9, 2003; and U.S. application Ser. No. 10/804,820, filed Mar. 19, 2004, are incorporated herein by reference, in their entirety. Aspects of the invention can be modified, if necessary, to employ systems, circuits and concepts of the various patents, applications and publications to provide yet further embodiments of the invention.

These and other changes can be made to the invention in light of the above-detailed description. In general, in the following claims, the terms used should not be construed to limit the invention to the specific embodiments disclosed in the specification and the claims, but should be construed to include all ADC validation systems and methods that operate in accordance with the claims. Accordingly, the invention is not limited by the disclosure, but instead its scope is to be determined entirely by the following claims.

1. A method of operating a validation system to validate automatic data collection devices, the method comprising:
automatically determining at least one data collection capability of an automatic data collection device remotely located from a validation system;
determining at least one test appropriate for testing the at least one data collection capability of the automatic data collection device based on the determined at least one capability of the automatic data collection device;
providing the determined at least one test to the automatic data collection device for execution; and
receiving a set of results from the execution of the determined at least one test by the automatic data collection device.

2. The method of claim 1 wherein automatically determining at least one data collection capability of an automatic data collection device remotely located from a validation system comprises determining whether the automatic data collection device is capable of reading at least one of a machine-readable optical symbol, a radio frequency identification tag, and a magnetic stripe.

3. The method of claim 1 wherein automatically determining at least one data collection capability of an automatic data collection device remotely located from a validation system comprises determining whether the automatic data collection device is capable of optically scanning or optically imaging a machine-readable optical symbol.

4. The method of claim 1 wherein automatically determining at least one data collection capability of an automatic data collection device remotely located from a validation system comprises determining at least one machine-readable optical pattern symbology which the automatic data collection device is capable of reading.

5. The method of claim 1 wherein determining at least one test appropriate for testing the at least one data collection capability of the automatic data collection device based on the determined at least one capability of the automatic data collection device comprises comparing a product identifier to a mask for appropriate tests.

6. The method of claim 1 wherein providing the determined at least one test to the automatic data collection device for execution comprises:
selecting a test from a set of predefined tests; and
uploading an executable version of the selected test to the automatic data collection device.

7. The method of claim 1 wherein providing the determined at least one test to the automatic data collection device for execution comprises:
manually preparing a new set of test instructions; and
uploading an executable version of the new set of test instructions to the automatic data collection device.

8. The method of claim 1, further comprising:
determining at least one platform capability of an automatic data collection device platform to which the automatic data collection device is communicatingly coupled;
determining at least one test appropriate for testing the at least one platform capability of the automatic data collection device platform based on the determined at least one capability of the automatic data collection device platform;
providing the determined at least one test to the automatic data collection device platform for execution; and
receiving a set of results from the execution of the determined at least one test by the automatic data collection device platform.

9. The method of claim 8 wherein determining at least one platform capability of an automatic data collection device platform to which the automatic data collection device is communicatingly coupled comprises determining a version of at least one set of instructions being executed by the automatic data collection device platform and/or a communications protocol used by the automatic data collection device platform to communicate with the automatic data collection device.

10. The method of claim 9, further comprising:
providing an updated version of the set of instructions to the automatic data collection device platform for execution thereby in place of the determined version of the at least one set of instructions being executed by the automatic data collection device platform.

11. The method of claim 8, further comprising:
automatically analyzing the received set of test results; and
automatically reporting the analysis of the test results to a number of defined users.

12. A validation system to validate automatic data collection devices, the system comprising:
means for automatically determining at least one data collection capability of an automatic data collection device remotely located from a validation system;
means for determining at least one test appropriate for testing the at least one data collection capability of the automatic data collection device based on the determined at least one capability of the automatic data collection device;
means for providing the determined at least one test to the automatic data collection device for execution; and
means for receiving a set of results from the execution of the determined at least one test by the automatic data collection device.

13. The validation system of claim 12, further comprising:
means for determining at least one platform capability of an automatic data collection device platform to which the automatic data collection device is communicatingly coupled;
means for determining at least one test appropriate for testing the at least one platform capability of the automatic data collection device platform based on the determined at least one capability of the automatic data collection device platform.

14. The validation system of claim 12, further comprising:
means for providing an updated version of the set of instructions to the automatic data collection device platform for execution thereby in place of the determined version of the at least one set of instructions being executed by the automatic data collection device platform.

15. A method of assessing automatic data collection devices, the method comprising:
automatically determining at least one capability of at least one of an automatic data collection device platform and/or an automatic data collection device associated with the automatic data collection device platform;
determining at least one appropriate test based on the determined capability of the automatic data collection device platform and/or automatic data collection device;
providing the determined at least one appropriate test to the automatic data collection device platform and/or automatic data collection device; and
receiving results from the execution of the determined at least one appropriate test.

16. The method of claim 15, further comprising:
determining whether an update of instructions is available; and
providing at least one of a software or a firmware update of instructions to the automatic data collection device platform and/or automatic data collection device associated with the automatic data collection device platform before providing the determined at least one appropriate test to the automatic data collection device platform and/or automatic data collection device.

17. The method of claim 15, further comprising:
executing the determined at least one appropriate test provided to the automatic data collection device platform and/or automatic data collection device on the at least one of the automatic data collection device platform and/or the automatic data collection device.

18. The method of claim 15, further comprising:
locating the at least one automatic data collection device platform and/or automatic data collection device on a communications network before automatically determining at least one capability of at least one of an automatic data collection device platform and/or an automatic data collection device associated with the automatic data collection device platform.

19. The method of claim 15 wherein providing the determined at least one appropriate test to the automatic data collection device platform and/or automatic data collection device comprises:
selecting a test from a set of predefined tests; and
uploading an executable version of the selected test to at least one of the automatic data collection device platform and/or the automatic data collection device.

20. A validation system to validate automatic data collection devices, the validation system comprising:
at least one processor;
a communications port operable to communicatively couple the processor to the automatic data collection devices; and
at least one processor readable medium storing instructions for causing the at least one processor to validate automatic data collection devices by:
automatically determining at least one capability of at least one of an automatic data collection device platform and/or an automatic data collection device associated with the automatic data collection device platform;
determining at least one appropriate test based on the determined capability of the automatic data collection device platform and/or automatic data collection device;
providing the determined at least one appropriate test to the automatic data collection device platform and/or the automatic data collection device; and
receiving results from the execution of the determined at least one appropriate test.

21. The validation system of claim 20 wherein the at least one processor readable medium stores instructions for causing the at least one processor to validate automatic data collection devices further by:
locating the at least one automatic data collection device platform and/or the automatic data collection device on a communications network before automatically determining at least one capability of at least one of an automatic data collection device platform and/or an automatic data collection device associated with the automatic data collection device platform.

22. The validation system of claim 21, further comprising:
at least one data storage device communicatively coupled to the processor, the at least one automatic data storage device storing a set of predefined tests from which at least one appropriate test is determined.

23. The validation system of claim 22 wherein the at least one processor readable medium stores instructions for causing the at least one processor to validate automatic data collection devices further by:
selecting a test from the set of predefined tests stored in the at least one data storage device; and
uploading an executable version of the selected test to at least one of the automatic data collection device platform and/or the automatic data collection device.

24. The validation system of claim 20 wherein the at least one processor readable medium stores instructions for causing the at least one processor to validate automatic data collection devices further by:
determining whether an update of instructions is available; and
providing at least one of a software or firmware update of instructions to the automatic data collection device platform and/or the automatic data collection device associated with the automatic data collection device platform before providing the determined at least one appropriate test to the automatic data collection device platform and/or the automatic data collection device.

25. The validation system of claim 20 wherein the at least one processor readable medium stores instructions for causing the at least one processor to validate automatic data collection devices further by:
automatically analyzing the results received from the execution of the determined at least one appropriate test; and
automatically reporting the analysis of the results.
